(19) United States
(12) Patent Application Publication
(10) Pub. No.: US 2010/0275786 A1
(43) Pub. Date: Nov. 4, 2010

(54) BEVERAGE DISPENSER WITH COHESIVE SEALING PART AT THE TAP UNIT

(76) Inventors: Peter Brezovnik, Mozirje (SI); Henrik Pavlovic, Ljubno ob Savinji (SI); Aleksander Sedovsek, Mozirje (SI); Igor Zibret, Smartno ob Paki 13 (SI)

Correspondence Address: FITCH EVEN TABIN & FLANNERY, 120 SOUTH LASALLE STREET, SUITE 1600, CHICAGO, IL, 60603-3406, US

(21) Appl. No.: 12/738,488

(22) PCT Filed: Sep. 24, 2008
(86) PCT No.: PCT/EP2008/062785

§ 371 Date: Jul. 15, 2010

(30) Foreign Application Priority Data
Oct. 16, 2007 (DE) 10 2007 049 601.1

(51) Int. Cl. A47J 31/44; B67D 7/82

(52) U.S. Cl. 99/295; 222/146.2

(57) ABSTRACT

An automatic beverage dispenser comprises a receptacle for beverage substrate cartridges, one tap unit for a hot water inlet and one tap unit for dispensing a beverage into the receptacle for tapping the cartridge upon preparation of a beverage. The tap units are disposed on a common holder on the same side of the inserted cartridge, which is further improved by seals on each tap unit for the fluid-tight sealing thereof against the cartridge during the preparation operation. The seals are configured as a cohesive sealing part.

The invention relates to a hot beverage dispenser with a receptacle for beverage substrate cartridges and with a Piercer for a hot water inlet and a tap unit for dispensing the beverage product in the receptacle. The tap units serve for piercing the cartridge in the preparation of the beverage and are arranged on the same side of the inserted cartridge and are disposed on a common holder.

An automatic beverage dispenser of this type is disclosed in WO 2005/079637 A1. It possesses a fold-up receptacle for beverage cartridges which, at the same time represents a type of brewing chamber. For the preparation of a beverage it is loaded with a substrate cartridge which must be inserted in a prescribed orientation in the receptacle. When closing the brewing chamber, this is opened by tap units which provide an inlet and an outlet. Hot water is fed through the inlet from below decentrally into the cartridge. In the cartridge, the hot water releases a beverage pre-product or brews a grist, for instance coffee, contained in the cartridge. The contained beverage fed out of the bottom centrally punched outlet of the cartridge which is arrangement at a distance from the inlet. After the preparation of the desired beverage, the receptacle can be opened, the empty substrate cartridge removed and replaced by a fresh cartridge.

As the substrate cartridges are pierced from the bottom, it is possible for fluids in the area of the tap units to flow out and to soil the inner space of the receptacle.

In order to obtain a perfect function of the automat the receptacle must be cleaned relatively often in the area of the tap unit. For this purpose the tap units are fixed to a common holder that can be removed from the receptacle. However, when removing the holder, individual parts such as a seal at a tap unit can be lost.

Therefore it is the aim of the invention to present an automatic beverage dispenser whose cleaning is less problematic.

This problem is solved with a hot beverage dispenser of the type mentioned above whose seals are attached to each tap unit and which, during the preparation procedure, seal the tap unit against the cartridge in a fluid-tight manner and which is formed as an interconnected cohesive sealing part. Therefore, in the removal of the tap unit for cleaning the loss of individual seals and thus an interruption of the function of the automat need no longer be feared. The seals now rather represent a single component, which are easier to handle because of their size and cannot easily be lost.

According to an advantageous design, the cohesive sealing part can be two seals designed as annular sections that can be positioned concentrically about the tap unit and linked together by a mostly flat band-shaped connecting strip.

The connecting strip connects the seals permanently and undetachably together. It extends approximately over the distance that the two seals are apart in the operating condition. A larger length of the connecting strip between the two seals is not required as a surplus length, when installed, could interfere with the operation. Attached to one side of the two seals, a strip however can serve for the easier removal of the cohesive sealing part for cleaning and service purposes.

According to an advantageous design of the discovery, the cohesive sealing part can be designed as a form part that can be inserted into a take-up recess with a corresponding form in the holder. As the cohesive sealing part consists of an elasticised, thus a deformable, soft material, whereas the holder is inherently stable, for instance manufactured of hard plastic, the cohesive sealing part can be fastened in the holder by means of form closure, so that no additional fastening medium is required. In this way, a simple assembly and disassembly of the cohesive sealing part can be achieved.

According to a further advantageous design of the discovery, the cohesive sealing part can be inserted into the holders on the cartridge side into the take up recess of the holder. In this way it can be separately removed and cleaned with opened receptacle without removal of the whole holder. Because it is accessible from an opening side of the receptacle it is particularly easy to check its functionality and for instance inspected for external damage.

According to a further advantageous design of the discovery, the holder and the cohesive sealing part can be manufactured as one piece, for instance in two component (2K) technology. A one-piece manufacture saves the assembly step for fastening the cohesive sealing part in the holder. Further, in this way the cohesive sealing part is held undetachably in the holder so that also with less careful use and cleaning of the hot beverage dispenser, a loss of the seal and thus a loss of functionality of the beverage dispenser need not be feared. The 2K technology also results in the internal connection between the holder and the cohesive sealing part that remains in effect reliably and permanently.

The principle of the discovery is shown in greater detail on the basis of the following drawings. The drawings show:

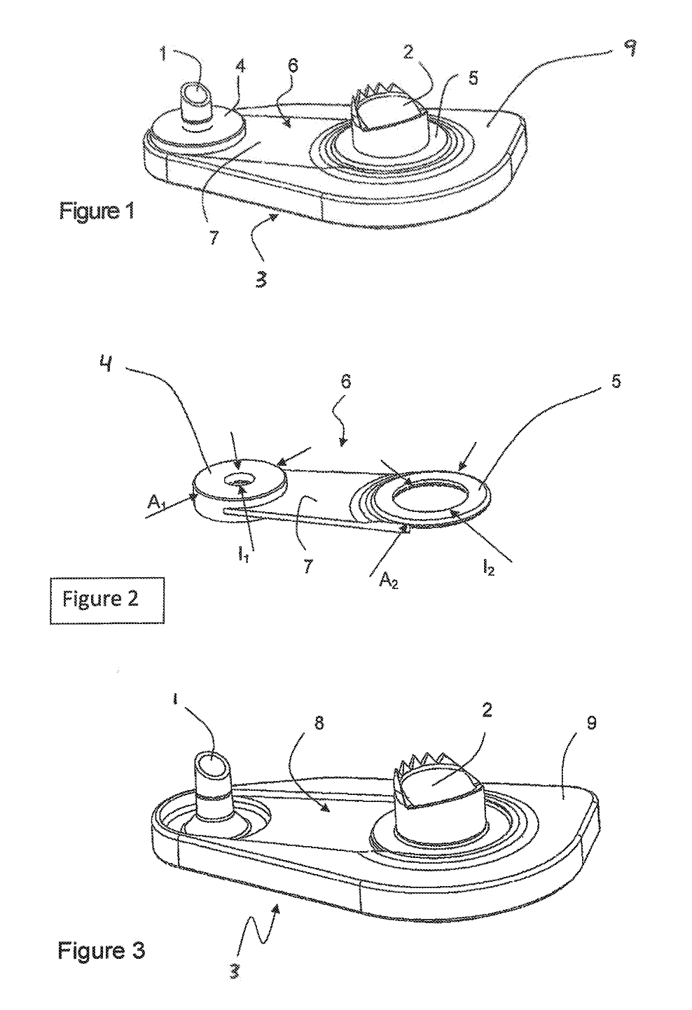

FIG. 1: A holder with tap units and seal,

FIG. 2: A cohesive sealing part by itself, and

FIG. 3: A holder without cohesive sealing part.

FIG. 1 shows a common holder 3 of a beverage dispenser. It is comprised of two tap units 1, 2 on a platform-type base body 9. Projecting vertically upwards in its horizontal built-in position in the automat, are two tap units 1, 2. Thus, in operation, they pierce a cartridge on the same side, namely on their bottom side. A seal 4, 5 concentrically surrounds both of the two tap units 1, 2. The seals 4, 5 ensure a fluid seal of the tap units 1, 2 against a pierced cartridge. Thus, they prevent soiling of the receptacle and reduce the cleaning effort of the dispenser

The tap units, 1, 2 are arranged at a certain distance apart in order to fully acquire the beverage product in the cartridge in the inlet and outlet of water. Accordingly also the seals 4, 5 are arranged at a distance from one another on the holder 3. A connecting strip 7 runs between the two seals 4, 5 that connects them into a cohesive sealing part 6.

FIG. 2 shows the cohesive sealing part 6 itself. The seals 4, 5 are formed in an annular manner and possess different internal diameters according to the outside dimensions of the tap units 1, 2.

Accordingly also their outside diameters A1, A2 can vary but are shown almost the same size. The connecting strip 7 that extends between the annular seals 4, 5 unifies the seals 4, 5 into a cohesive sealing part 6. Because it only needs to keep the seals 4, 5 together, the strip 7 can save material by being flat. It is formed in one piece with the seals 4, 5 and, like them, made of an elasticised material. At its one end, the strip 7 connects to the seal 4. With both ends the strip 7 connects to the respective seals 4, 5 according to their outside diameters A1, A2.

FIG. 3 represents a holder 3 without the cohesive sealing part 6. A recess 8 is formed in its plate-form base body 9 around the tap units 1, 2 and between them, and in its form it corresponds to the cohesive sealing part 6. This can be placed flush in the recess 8 and kept there in a form-fit manner. The adhesion of the elasticised material of the cohesive sealing part 6 to the holder 3 ensures that it can be removed from the recess 8 without much effort. In this manner the cohesive sealing part 6 is reliably fastened in the recess 8 without needing addition al fastening media.

### LEGEND

1 Tap unit
2 Tap unit
3 Common holder
4 Seal
5 Seal
6 Cohesive sealing unit
7 Connecting strip
8 Recess
9 Base body of the common holder 3
A1 Outside diameter of the tap unit 1
A2 Outside diameter of the tap unit 2
I1 Inside diameter of the tap unit 1
I2 Inside diameter of the tap unit 2

1. A hot beverage dispenser having a receptacle for beverage substrate cartridges, the dispenser comprising a first tap unit for a hot water inlet and a second tap unit for dispensing a beverage into the receptacle for piercing a cartridge upon preparation of the beverage, wherein the first and second tap units are disposed on a common holder on the same side of the inserted cartridge, and each tap unit having a seal for fluid-tight sealing thereof against the cartridge during the preparation operation, the seals being configured as a cohesive sealing unit.

2. The hot beverage dispenser according to claim 1, wherein the cohesive sealing unit comprises two annular seals that are concentrically placed around the first and second tap units and that are connected together with an evenly flat connecting strip.

3. The hot beverage dispenser according to claim 1, wherein the cohesive sealing unit is formed as a part that can be inserted into a recess with a corresponding form in the common holder.

4. The hot beverage dispenser according to claim 3, wherein the cohesive sealing unit can be inserted on the cartridge side into the recess.

5. The hot beverage dispenser according to claim 1, wherein the common holder and the cohesive sealing unit are manufactured in one piece in 2K technology.

6. The hot beverage dispenser according to claim 2, wherein the cohesive sealing unit is formed as a part that can be inserted into a recess with a corresponding form in the common holder.
